(19) United States
(12) Patent Application Publication
(10) Pub. No.: US 2005/0132117 A1
(43) Pub. Date: Jun. 16, 2005

(54) [CARD READER, AND BRIDGE CONTROLLER AND DATA TRANSMISSION METHOD THEREOF]

(76) Inventor: Hsiang-An Hsieh, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/708,355

(22) Filed: Feb. 26, 2004

(30) Foreign Application Priority Data
Dec. 11, 2003 (TW) 92134971

(51) Int. Cl. G06F 12/00

(52) U.S. Cl. 710/313; 711/115

(57) ABSTRACT

A card reader, and a bridge controller and a data transmission method thereof are provided. The card reader comprises a silicon storage device connector and a bridge controller. The bridge controller further comprises a silicon storage device interface, a system interface, a microprocessor, a cache buffer, an allocation table buffer, and a transmission buffer. With the cooperation of the cache buffer and the allocation table buffer, the present invention can pre-save data in the cache buffer by using the data accessing address mapping table stored in the allocation table buffer, so as to improve the cache hit ratio and the data transmission speed.

### CROSS REFERENCE TO RELATED APPLICATIONS

This application claims the priority benefit of Taiwan application serial no. 92134971, filed Dec. 11, 2003.

### BACKGROUND OF INVENTION

1. Field of the Invention

The present invention relates to a card reader, and more particularly, to a high speed performance card reader, and a bridge controller and a data transmission method thereof.

2. Description of the Related Art

Along with the progress of the new technologies, the size of the storage media, such as, the popular portable disk or flash memory card developed from the semiconductor technique are getting smaller. The storage media is composed of a memory formed by the silicon chip, thus it is commonly called as a silicon storage device.

For meeting the demand of the silicon storage device applications, a card reader used in a general personal computer for accessing the silicon storage device mentioned above has been developed. The bridge controller of the card reader is mainly comprised of a system interface, a silicon storage device interface, a microprocessor, and a transmission buffer. Wherein, the system interface comprises interface which is commonly used as an interface in the personal computer, such as USB, IEEE 1394, IDE/ATAPI, PCMCIA, and SATA, etc. The silicon storage device interface comprises different type of the silicon storage device interfaces and each of the interfaces is dedicated to a specific silicon storage device standard, such as Compact Flash, Smart Media, Secure Digital, Multimedia Card, Memory Stick, and Memory Stick Pro, etc.

The data access rate of the silicon storage device interface in the conventional art mentioned above is limited by the memory access rate of the silicon storage device, thus it is commonly lower than the data access rate of the external system interface which is connected to the silicon storage device. In addition, in the case that the data access rate of the external system interface is greatly improved, the difference between the data access rate of the external system interface and the silicon storage device interface is gradually increased accordingly. Such data transmission delay impedes the system to fully deploy its computing power, and further impacts the user operative efficiency.

### SUMMARY OF INVENTION

In the light of the preface, it is an object of the present invention to provide a card reader, and a bridge controller and a data transmission method thereof. With the bridge controller of the card reader and by using the data transmission method thereof, the data transmission rate between the silicon storage device and the system connected to the card reader is effectively improved.

A card reader provided by the present invention comprises a silicon storage device connector and a bridge controller. The silicon storage device connector contains and electrically couples to the silicon storage device, and the bridge controller electrically couples to the silicon storage device connector. When the bridge controller receives a read instruction, it prefetches a portion of data which is not requested by the read instruction from the silicon storage device, and saves the portion of data in the bridge controller.

The present invention further provides a bridge controller of the card reader. The bridge controller electrically couples to the silicon storage device connector, and the silicon storage device connector contains and electrically couples to the silicon storage device. The bridge controller of the card reader comprises a microprocessor, a silicon storage device interface, a system interface, a cache buffer, and a transmission buffer. Wherein, the silicon storage device interface accesses the silicon storage device according to the microprocessor instructions. The system interface receives the operating instructions. The cache buffer electrically couples to the silicon storage device interface and the system interface, whereas the transmission buffer electrically couples to the microprocessor, the silicon storage device interface, and the system interface. If the operating instruction is a read instruction, the microprocessor predicts and saves the prefetched data which is not requested by the read instruction in the cache buffer or in the transmission buffer.

In a preferred embodiment of the present invention, the bridge controller mentioned above further comprises an allocation table buffer, which is electrically coupled to the system interface and the silicon storage device interface for storing a data accessing address mapping table.

The present invention further provides a data transmission method for the card reader. The method is suitable for a card reader comprising a transmission buffer, a cache buffer, a system interface and a silicon storage device interface. The data transmission method for the card reader comprises: a first data which is requested by the read instruction is first received by at least one of the transmission buffer and the cache buffer; then after either the transmission buffer or the cache buffer is full, a second data which is predicted by the card reader and which is not requested by the read instruction is saved in either the transmission buffer or the cache buffer that is not full yet. Meanwhile or afterwards, the card reader receives a read instruction subsequent to the read instruction mentioned above, compares and determines whether the second data is matched with a third data requested by the subsequent read instruction. If the second data matches the third data, the card reader sends out the second data.

In an embodiment of the present invention, the step of determining whether the second data is matched with the third data comprises: determining whether the address of the second data is contained in the address of the third data, or whether the address of the third data is contained in the address of the second data.

In another embodiment of the present invention, the data transmission method for the card reader mentioned above further comprises: when the second data is not matched with the third data, the second data from the transmission buffer or the cache buffer is removed.

In yet another embodiment of the present invention, if the card reader comprises an allocation table buffer, the data transmission method for the card reader mentioned above can pre-save a data accessing address mapping table in the allocation table buffer, and the content of the data accessing address mapping table is updated according to the write instruction when receiving the write instruction and writing the data, and the data is directly written into the silicon storage device from the cache buffer according to the updated content of the data accessing address mapping table. Then, after the writing operation is completed, the data accessing address mapping table is written into the silicon storage device. Wherein, while the microprocessor is decoding the write instruction, the cache buffer continuously receives the written data transmitted by the system interface simultaneously. After the microprocessor completes the decoding operation, the written data is directly written into the silicon storage device from the cache buffer.

The present invention further provides a data transmission method for the card reader. The method is suitable for a card reader, which comprises a transmission buffer, a cache buffer, a system interface, and a silicon storage device interface. The data transmission method for the card reader comprises: the transmission buffer receives a first data requested by a read instruction; the card reader predicts the second data not requested by the read instruction after the transmission buffer is full; and the second data is saved into the cache buffer. Meanwhile or afterwards, the card reader receives a read instruction subsequent to the read instruction mentioned above, compares and determines whether the second data is matched with a third data requested by the subsequent read instruction. If the second data matches with the third data, the card reader sends out the second data.

In a preferred embodiment of the present invention, in order to comply with the file access requirement of the system interface, a plurality of file minimum access units, such as clusters, is allocated to the cache buffer and forms its storage capacity. Therefore, the increasing frequency of accessing the system interface caused by the insufficient access amount provided by the silicon storage device is decreased.

In summary, the present invention pre-saves the data which is in the silicon storage device and is not accessed yet, so as to reduce the number of searching the silicon storage device and to improve the data transmission performance. In addition, with the cooperation of the cache buffer and the allocation table buffer, the hit ratio of the cached data is also improved. Moreover, with the allocation table buffer, the number of accessing the silicon storage device is reduced and the data access rate is indirectly improved. Finally, in the present invention, by appropriately increasing the cache buffer capacity, the number of the accessing operations of data transmission is reduced, and the possibility that the system end is interrupted by the card reader is also decreased. By providing the advantages and techniques mentioned above, the present invention is expected to be the mainstream of the media device such as the memory card and the portable disk which is used to replace the floppy disk and the optical disc currently used.

### BRIEF DESCRIPTION OF DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 is a circuit diagram of a card reader bridge controller according to an embodiment according of the present invention.

FIG. 2 is a circuit diagram illustrating a card reader connected to an external system and a silicon storage device according to an embodiment of the present invention.

FIG. 3A˜3C are the diagrams illustrating a reading operation of a card reader according to an embodiment of the present invention.

FIG. 3D is a flow chart illustrating a data transmission method for a card reader bridge controller according to an embodiment of the present invention.

FIG. 4A˜4B are the diagrams illustrating a write operation of a bridge controller according to an embodiment of the present invention.

FIG. 5 is a circuit diagram of a card reader bridge controller according to an embodiment according of the present invention.

FIG. 6A˜6C are the diagrams illustrating a reading operation of a card reader bridge controller according to an embodiment of the present invention.

FIG. 7A˜7B are the diagrams illustrating a write operation of a card reader bridge controller according to an embodiment of the present invention.

FIG. 8 is a file linkage allocation table according to an embodiment of the present invention.

### DETAILED DESCRIPTION

FIG. 1 is a circuit diagram of a card reader bridge controller according to an embodiment according of the present invention. Referring to FIG. 1, the bridge controller 100 comprises a system interface 112, a microprocessor 114, a silicon storage device interface 116, a transmission buffer 118, and a cache buffer 120. Wherein, the microprocessor 114 electrically couples to the system interface 112 and the silicon storage device interface 116. The transmission buffer 118 electrically couples to the microprocessor 114, the silicon storage device interface 116, the system interface 112, and the cache buffer 120. The cache buffer 120 electrically couples to the system interface 112 and the silicon storage device interface 116.

In addition, in the present embodiment, in order to comply with the amount required by the general file access, the capacity of the cache buffer 120 is designed as several times of the capacity of the transmission buffer 118, and it is composed of the file minimum access units (e.g. clusters) each at least comprises a plurality of sectors. For example, the cache buffer 120 uses a cluster (each is 4K bytes and able to contain 8 records of sector data) as its minimum storage amount setting. The capacity of the transmission buffer 118 is set as only 1K byte of the storage space (that is, it can contain only two records of sector data).

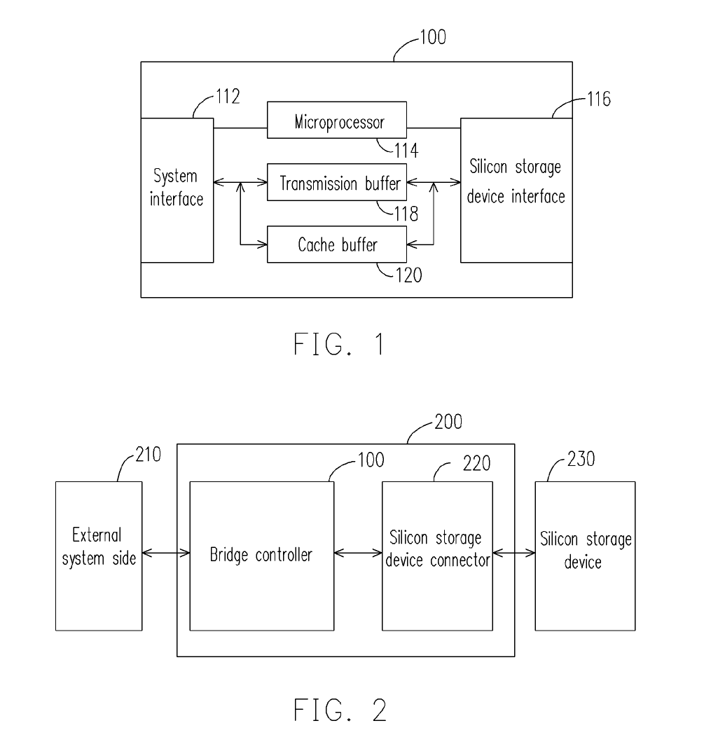

Referring to FIG. 2, which is a circuit diagram illustrating a card reader connected to an external system and a silicon storage device according to the first embodiment of the present invention. In the card reader 200, the bridge controller 100 is electrically coupled to the silicon storage device connector 220 through the silicon storage device interface 116, and the silicon storage device connector 220 contains and electrically couples to the silicon storage device 230 which is used to store data. In addition, the bridge controller 100 is further electrically coupled to an external system side 210 (e.g. a desktop computer, a notebook computer, or a digital personal computer assistant, etc.) via the system interface 112 (e.g. the transmission interface such as USB port, IEEE 1394, and PCMCIA, etc.), such that the data transmission can be performed between the bridge controller 100 and the external system side 210.

During the data transmission session, in general, the transmission buffer 118 caches the system instruction sent by the external system side 210 and/or the sector data which is desired to be accessed by the system instruction. In addition, in the present embodiment, the cache buffer 120 pre-saves the sector data which is not requested by the system instruction yet, and the data input/output operation between the system interface 112 and the silicon storage device interface 116 is alternately performed with the cooperation of the cache buffer 120 and the transmission buffer 118, so as to reduce or eliminate the buffering time required for caching data in the transmission buffer 118.

For example, under normal circumstance, the data read by the external system side 210 is the sector data which is either stored in the contiguous sector addresses of the silicon storage device 230 or belonging to the same file but stored in the non-contiguous sectors, respectively. In order to do this, when the card reader 200 is in the reading state, i.e. when the bridge controller 100 has to provide the data to the external system side 210, the two sector data mentioned above are considered as having higher priority t sector data which needs to be pre-saved by the cache buffer 120. With this implementation, the card reader 200 not only support the general standard access mode, but also support the cache access mode with the help of allocating the cache buffer 120.

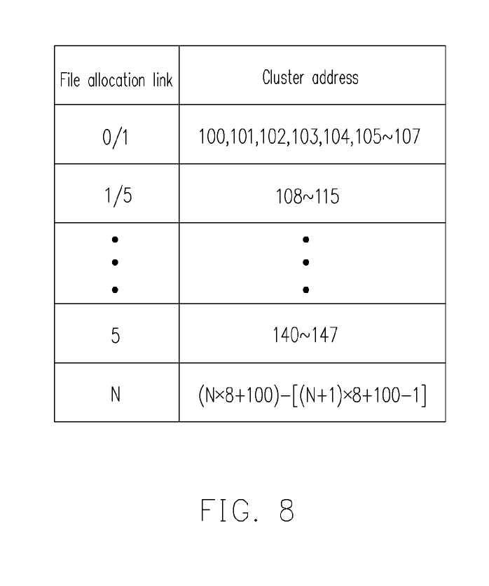

In the cache access mode, if the data to be pre-saved by the cache buffer 120 is the contiguous sector data which is stored in the silicon storage device 230 and is specified by the read instruction of the external system side 210, the microprocessor 114 can easily determine which sector data is to be pre-saved into the cache buffer 120 according to the read instruction. However, if the sector data to be pre-saved by the cache buffer 120 is the sector data belonged to the same file but stored in the non-contiguous sectors, it is recommended to refer to a file allocation table (FAT) which stores a data accessing address mapping table illustrating the relationship between the file and the cluster (as shown in FIG. 8).

Since the sector data which may be requested by the subsequent instruction of the external system side 210 is pre-saved in the cache buffer 120, in the cache access mode, as long as the subsequent instruction of the external system side 210 is a read instruction against the silicon storage device 230 and it is determined by the microprocessor 114 that the sector data pre-saved in the cache buffer 120 is matched to the data requested by the subsequent read instruction, the microprocessor 114 can directly upload the sector data pre-saved in the cache buffer 120 to the external system end 210 without having to perform the operations like in the standard access mode. Wherein, in the standard access mode, each time when receiving a read instruction, it is required to perform whole operations starting from searching the silicon storage device 230 to a series of subsequent preparation operations according to the read instruction, and the data is not provided until all subsequent data preparation operations are finished.

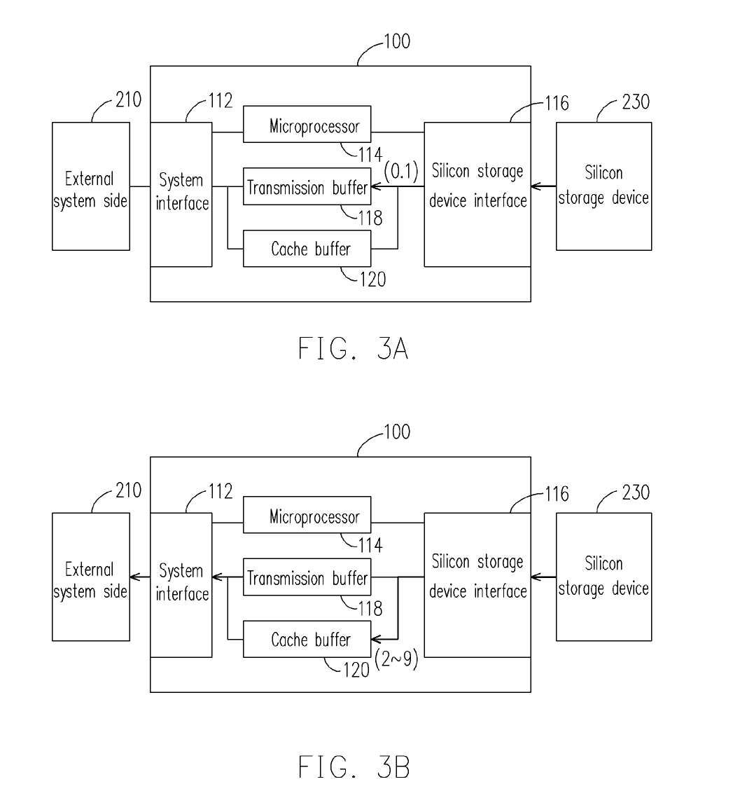

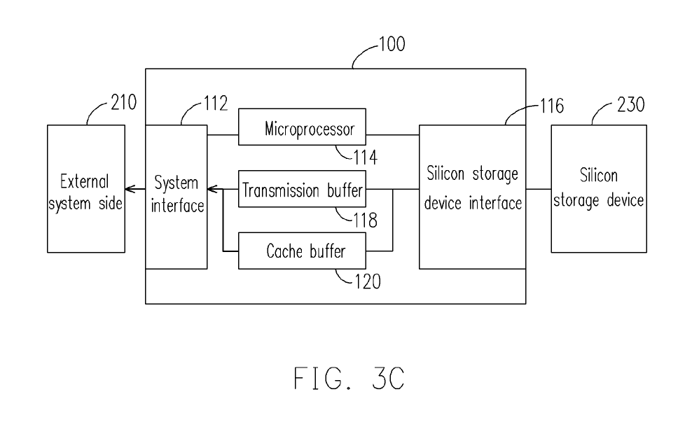

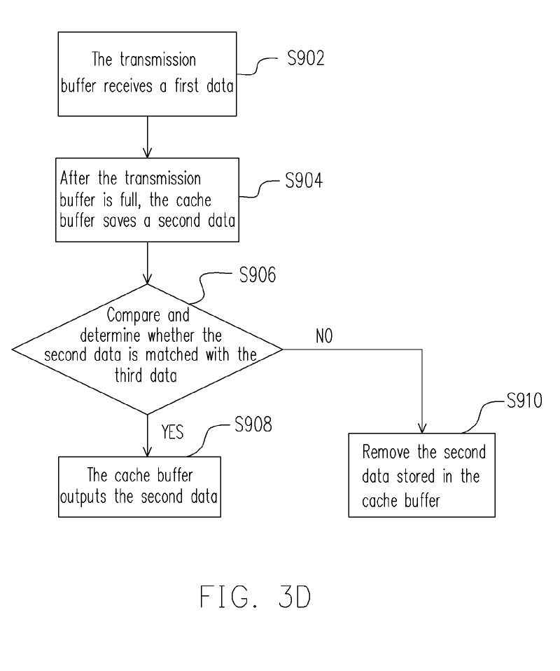

FIG. 3A˜3C are the diagrams illustrating a reading operation of a card reader according to an embodiment of the present invention. Wherein, in order to make the drawing more clear and easy to understand, in the present embodiment, besides the bridge controller 100 and the internal circuit blocks thereof, other circuit in the card reader 200 such as the silicon storage device connector 220 is not specifically indicated herein. Referring to FIG. 3A, if the first system instruction received by the microprocessor 114 of the bridge controller 100 is R(0, 1), after decoding and converting the address, it is known that the system instruction is a read instruction (R) and the read address is (0, 1), respectively. Then, the silicon storage device 230 searches the corresponding sector address, extracts the corresponding sector data according to the sector address 0 and 1, and saves it in the transmission buffer 118.

Referring to FIG. 3B, since the transmission buffer 118 can only accommodate two records of sector data, after saving the data requested by the first system instruction, the transmission buffer 118 becomes full. Meanwhile, the microprocessor 114 orders the transmission buffer 118 to upload the sector data it saves to the external system side 210. Meanwhile, the microprocessor 114 continuously preloads the corresponding contiguous sector data subsequent to the sector 1 from the silicon storage device 230 to the cache buffer 120 while the transmission buffer 118 is performing the data uploading and a next instruction is not received yet due to the external system side 210 is busy in processing the sector data. Since the cache buffer 120 can accommodate 8 sector units, the sector data saved in the subsequent 8 contiguous sectors 2˜9 are preloaded into the cache buffer 120.

Referring to FIG. 3C, when the external system side 210 issues the read instruction again (it is referred as a subsequent instruction), and when it is partially or fully matched with the sector data pre-saved in the cache buffer 120 after the instruction is decoded and the address is converted by the microprocessor 114 (this case is referred as a “cache hit”), the microprocessor 114 directly uploads the sector data which is “cache hit” to the external system side 210 from the cache buffer 120. Wherein, the “cache hit” mentioned above comprises two situations, one case is when the address of the sector data (also known as a second data) in the cache buffer 120 is contained in the address of the data (also known as a third data) requested by the subsequent read instruction; and the other case is when the address of the third data is contained in the address of the second data. In both cases, since the second data and the third data are at least partially matched, both cases are “cache hit”.

In the embodiment mentioned above, the microprocessor 114 predicts the sector data to be saved to the cache buffer 120 according to the contiguous sector data. However, as mentioned above, the microprocessor 114 also can predict the sector data to be saved according to the sector data belonging to the same file. Referring to FIG. 8, it is assumed that the content of the data accessing address mapping table for a specific file contains three portions including the file allocation link 0, 1, and 5, and the physical address corresponding to each portion contains a cluster of no. 100˜107, 108˜115, and 140˜147, respectively. As to the microprocessor 114, which predicts the sector data according to the sector data belonged to the same file, the early stage of the data transmission process is the same as the case of the contiguous sector data mentioned above, thus its detail description is omitted herein. However, once it is started to transmit the data of cluster 107 (including 8 contiguous sector data) to the external system side 210, the microprocessor 114 points to the allocation link 1, that is, saves the second portion of the file, obtains each sector data contained in the cluster from the cluster 108, and respectively saves the obtained sector data into the transmission buffer 118 or the cache buffer 120 based on the real situation.

With the access mode mentioned above, the search time and frequency required by the bridge controller 100 is reduced. As to the external system side 210, since the data search operation of the bridge controller 100 is performed simultaneously with the data transmission, the time spent in waiting for the external system side 210 is obviously shortened, thus the whole processing speed is further improved. With two different predicting mechanisms mentioned above, the microprocessor 114 can predict the sector data which may be requested by the subsequent read instruction more accurately, such that the cache hit ratio is significantly improved. However, it is to be noted that once the sector data, which is requested by the instruction subsequent to the read instruction is not matched to the sector data pre-saved in the cache buffer 120, or if the subsequent instruction is a write instruction, the microprocessor 114 must remove the sector data pre-saved in the cache buffer 120.

Referring to FIG. 3D, a flow chart illustrating a data transmission method for a card reader bridge controller according to an embodiment of the present invention is shown. In addition, for simplification, same reference number for elements shown in FIG. 3A.

In the present embodiment, the data transmission operation is alternately and synchronously performed between the cache buffer 120 and the transmission buffer 118. In other words, the transmission buffer 118 first receives a first data requested by the read instruction (i.e. the data saved in the sector 0, 1 mentioned above as shown in step S902) from the silicon storage device 230. The read instruction is received by the system interface 112. Then, the microprocessor 114 searches and fetches the corresponding first data from the silicon storage device 230 which is connected to the silicon storage device interface 116, and saves the first data in the transmission buffer 118.

Afterwards, after the transmission buffer 118 is full, the microprocessor 114 control the system interface 112 to transmit the first data stored in the transmission buffer 118 to the external system side 210, predicts the second data which is stored by not requested by the read instruction yet (i.e. the data saved in the sector 2˜9 as shown in FIG. 3B), and pre-saves the second data to the cache buffer 120 from the silicon storage device 230 (step S904). Then, the second data is compared with the third data, which is desired to be read by a read instruction subsequent to the read instruction and it is determined whether the second data is matched with the third data (step S906). If it is determined that the second data matches with the third data, after the first data has been transmitted, the second data saved in the cache buffer 120 is directly transmitted to the external system side 210 through the system interface 112 (step S908). Otherwise, if the second data is not matched to the third data, the sector data pre-saved in the cache buffer 120 is removed (step S910).

It is to be emphasized that even though the data is pre-saved in the transmission buffer 118 first, and then other data is pre-saved in the cache buffer 120 when the transmission buffer 118 is full in the embodiments mentioned above. It will be apparent to one of the ordinary skill in the art that the data can also be stored in the cache buffer 120 first, and other data can be stored in the transmission buffer 118 when the cache buffer 120 is full or some free space has been emptied from the transmission buffer 118.

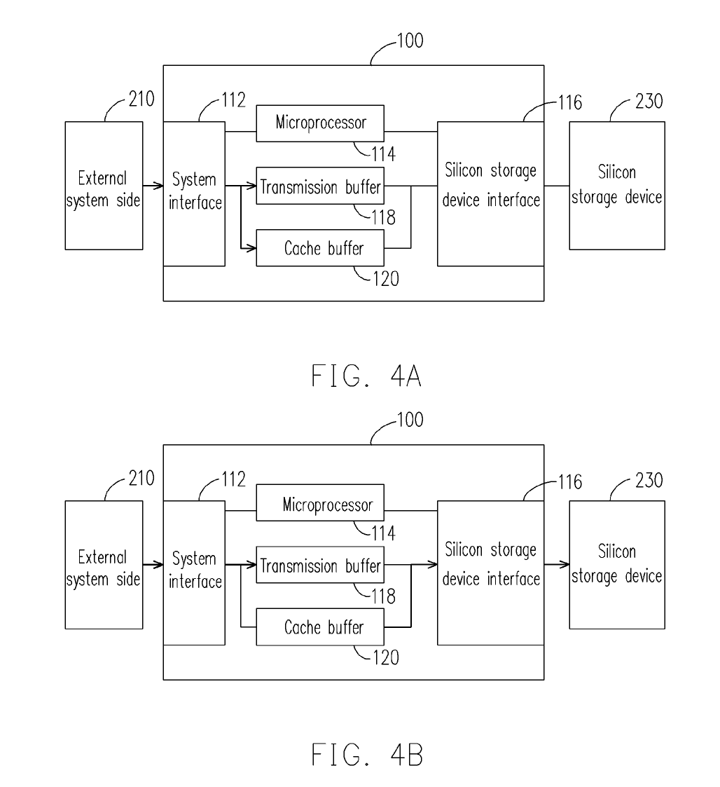

FIG. 4A˜4B are the diagrams illustrating a write operation of a bridge controller according to the first embodiment of the present invention. Referring to FIG. 4A, when the transmission buffer 118 receives a write instruction from the external system side 210, and when the microprocessor 114 is fetching the system instruction from the transmission buffer 120 for decoding the instruction, the cache buffer 120 continuously receives the to-be-written sector data which is transmitted from the external system side 210 at the same time.

Referring to FIG. 4B, after the microprocessor 114 completes the decoding operation, the pre-saved to-be-written sector data is directly written into the silicon storage device 230 through the silicon storage device interface 116 from the cache buffer 120. Since the cache buffer 120 used in the present embodiment can accommodate a cluster unit of storage space, a great amount of data can be written into the silicon storage device 130 at a time. In addition, similar to the simultaneously output of the reading, while the cache buffer 120 is transmitting the to-be-written data to the silicon storage device 230 through the silicon storage device interface 116, the transmission buffer 118 which is now empty continuously receives the sector data transmitted from the external system side 210, such that the frequency and time spent in interrupting the external system side 210 for requesting the data transmission is decreased.

In addition, while the write operation mentioned above is running, the to-be-written data is written to the silicon storage device 230, and the mapping address corresponding to the written sector data is updated to the data accessing address mapping table (or the file allocation table) in the silicon storage device 230. Moreover, the process of obtaining the physical address by referring to the data accessing address mapping table is inevasible in both reading and writing operations. However, the rewriting or referring process mentioned above no doubt incurs a certain amount of time delay for the whole accessing operation.

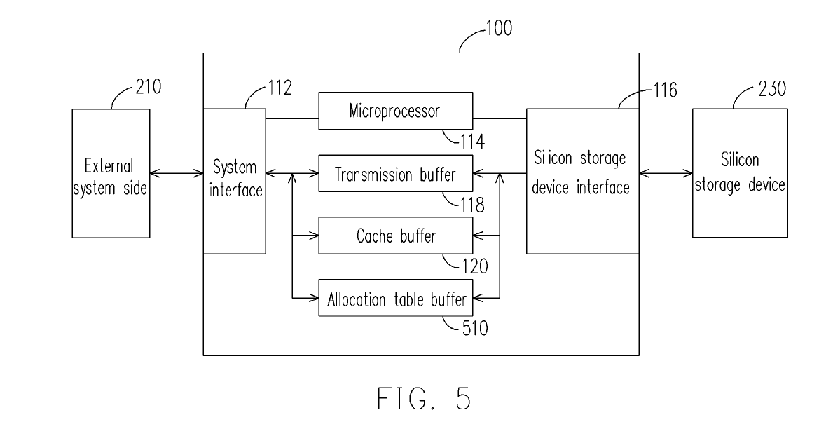

In order to resolve this problem, in an embodiment of the present invention, the data accessing address mapping table is saved in a memory having a faster access speed, such that the number of accessing the silicon storage device 230 can be reduced. Referring to FIG. 5, which is a circuit diagram of a card reader bridge controller according to a second embodiment according of the present invention. Wherein, in order to reduce the number of updating the silicon storage device 230 having a slower access speed, the present embodiment allocates an allocation table buffer 510 in between the system interface 112 and the silicon storage device interface 116, and the allocation table buffer 510 is used to save a data accessing address mapping table such as a file allocation linkage table like FAT or the one shown in FIG. 8. The data accessing address mapping table contains the cluster logical address of the file allocation link which is desired to be accessed and the correlation among the sector physical addresses in the silicon storage device 230.

With the new added allocation table buffer 510, while modifying the content of the data accessing address mapping table, only part of the data stored in the allocation table buffer 510 has to be modified first, and the modified data can be written into the silicon storage device 230 when the bridge controller 100 is idle, thus the requirement of accessing the silicon storage device 230 caused by updating the data accessing address mapping table is decreased. Furthermore, during both reading and writing operations, it is possible to quickly obtain the physical memory address to be accessed by only referring to the content stored in the allocation table buffer 510. Therefore, the requirement of accessing the silicon storage device 230 caused by referring to the data accessing address mapping table is also decreased.

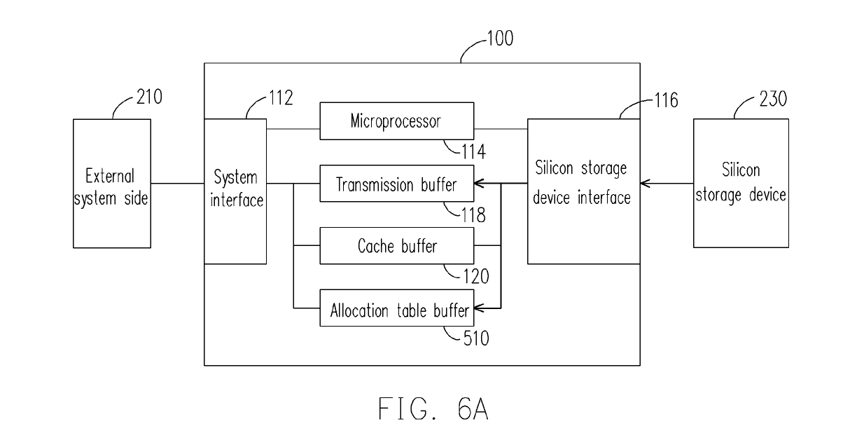

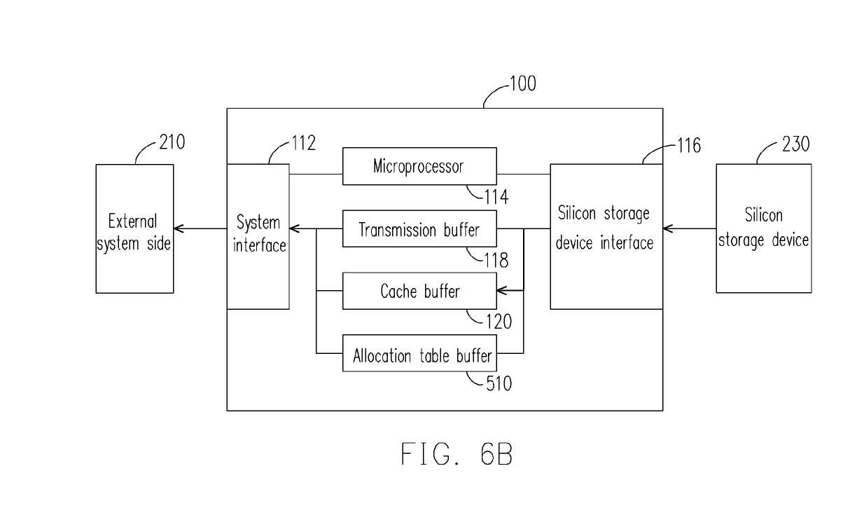

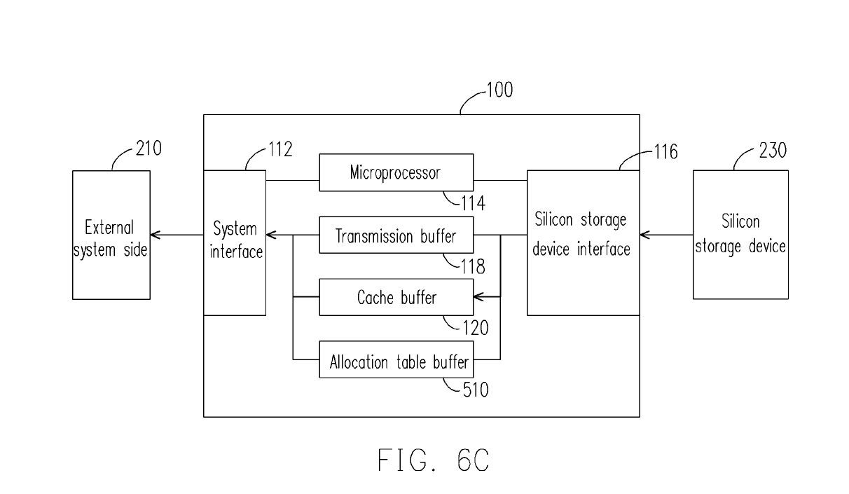

FIG. 6A˜6C are the diagrams illustrating a reading operation of a card reader bridge controller according to the second embodiment of the present invention. Referring to FIG. 6A˜6C, in the present embodiment, the cache mode of the present invention is described in detail when cooperated with the new added allocation table buffer 510. The file exemplified in the present embodiment are sequentially composed of a file allocation link 0 (cluster address 100˜107), a file allocation link 1 (cluster address 108˜115), and a file allocation link 5 (cluster address 140˜147).

Referring to FIG. 6A, before the external system side 210 starts to read the file stored in the silicon storage device 230, the microprocessor 114 in the bridge controller 100 makes a copy of the data accessing address mapping table in the silicon storage device 230 and saves the copy into the allocation table buffer 510. Then, each sector data in the cluster logical address 100 of the file allocation link 0 is fetched from the silicon storage device 230 and cached in the transmission buffer 118. However, due to the insufficient capacity of the transmission buffer 118, only two sector data in the cluster address 100 is cached.

Referring to FIG. 6B, once the transmission buffer 118 is full, the uploading of the sector data therein is started. During the upload process, the microprocessor 114 caches other 6 sector data in the cluster logical address 100 of the file allocation link specified by the external system side 210 in current time in the cache buffer 120 in the case when the cache buffer 120 is capable of accepting new load, and pre-saves the two sector data in the cluster logical address 101 which is not specified by the read instruction yet in current time into the cache buffer 120 when there is a free space in the cache buffer 120.

Referring to FIG. 6C, while the external system side 210 is reading the specified remaining sector data, the microprocessor 114 has to transmit other 6 sector data which is pre-saved in the cache buffer 120 and belonging to the cluster address 100 after transmitting the sector data which is saved in the transmission buffer 118 to the external system side 210. After the external system side 210 completes the receiving and processing operations for the cluster data 100, if the read instruction is issued again and the address of the data which is desired to be read is matched with the address of the data pre-saved in the cache buffer 120 (e.g. the cluster address 101), it is called as the “cache hit”, and the microprocessor 114 can directly upload the two sector data which is pre-saved and belonging to the cluster address 101 from the cache buffer 120.

Furthermore, while the cache buffer 120 starts to update data due to the cache hit, the transmission buffer 118 continuously receives the subsequent sector data which is not loaded into the cache buffer 120 yet. For example, when the cache buffer 120 only obtains the first two sector data of the cluster address 101 in the file allocation link 0 in the previous time, and starts to upload the sector data due to the cache hit, the transmission buffer 118 receives the subsequent sector data belonged to the cluster address 101. Accordingly, once the system empties the data in the cache buffer 120, the system can continuously obtain the subsequent sector data from the transmission buffer 118.

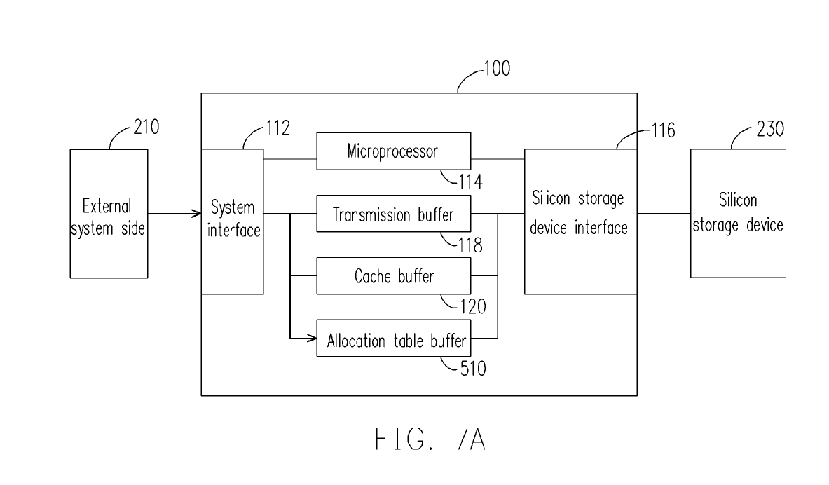

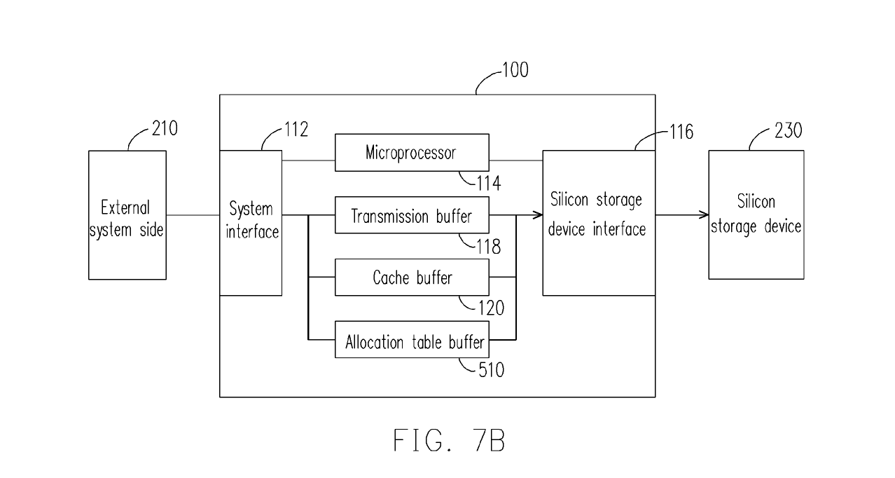

FIG. 7A˜7B are the diagrams illustrating a write operation of a card reader bridge controller according to the second embodiment of the present invention. Referring to FIG. 7A, while the transmission buffer 118 is receiving the write instruction transmitted by the external system side 210 and the microprocessor 114 is decoding the write instruction, the table content in the allocation table buffer 510 is updated each time when the write instruction is transmitted. Therefore, the microprocessor 114 can directly write the to-be-written sector data to the silicon storage device 230 through the memory interface 116 from the cache buffer 120 according to the updated table content in the allocation table buffer 510. However, the table content is not immediately written into the silicon storage device 230. Instead, the table content in the allocation table buffer 510 is updated to the silicon storage device 230 only when the writing operation of the external system side 210 is partially or totally completed (as shown in FIG. 7B) so as to decrease the frequency of updating the table in the silicon storage device 230.

In summary, since the present invention pre-saves the data which is stored in the silicon storage device and is not requested by the instruction yet, it can reduce the number of searching the silicon storage device and improve the transmission efficiency. Furthermore, with the cooperation of the cache buffer and the allocation table buffer, it not only increase the hit ratio of the cached data, but also reduce the number of accessing the silicon storage device in reading and writing operations, and so as to increase the data access rate indirectly. In addition, by appropriately increasing the cache buffer capacity, the number of the accessing operations for data transmission is reduced, and the possibility that the system end is interrupted by the card reader is also decreased.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

1. A card reader, comprising:
a silicon storage device connector, electrically coupled to a silicon storage device; and
a bridge controller, electrically coupled to the silicon storage device connector, wherein when the bridge controller receives a read instruction, the bridge controller prefetches a part of data requested by the read instruction from the silicon storage device in advance, and saves the part of data in the bridge controller.

2. A bridge controller, embedded in a card reader electrically coupling to a silicon storage device and an external system side, comprising:
a microprocessor;
a silicon storage device interface, accessing said silicon storage device according to instruction of the microprocessor;
a system interface, receiving data transferred from buffers respectively according to instruction of said microprocessor;
a transmission buffer, electrically coupled to said silicon storage device interface and said system interface; and
a cache buffer, overlapping said transmission buffer to couple with said silicon storage device interface and said system interface;
wherein, when said microprocessor outputting a read instruction, one of said buffers transferring alternatively to the system interface.

3. The bridge controller of claim 2, further comprising an allocation table buffer, electrically coupled to said system interface and said silicon storage device interface for storing a data accessing address mapping table.

4. The bridge controller of claim 2, wherein means for transmitting data transmission operation is alternately and synchronously performed between said cache buffer and said transmission buffer.

5. A method for data transmission of a card reader, wherein said card reader comprising a transmission buffer, a cache buffer, a system interface, and a silicon storage device interface, and said method comprising:
receiving a first data requested by a read instruction, wherein said first data is received by at least one of said transmission buffer and said cache buffer;
wherein when either said transmission buffer or said cache buffer approaching full status, the other buffer storing a second data predetermined by said read instruction; and
outputting sequentially said data stored in said transmission buffer and said cache buffer.

6. The method as cited in claim 5, said method further comprising a step for comparing said data stored in said buffers following said step of storing said second data, wherein said comparison step determining the first position of said second data following the last position of said first data.

7. The method as cited in claim 5, further comprising:
removing said data from said transmission buffer and said cache buffer after outputting said data.

8. The method as cited in claim 5, wherein said method is alternately and synchronously performed to transmit data.

9. The method as cited in claim 5, said card reader further comprising an allocation table buffer, and said method further comprising:
writing a data accessing address mapping table into said allocation table buffer;
updating content of said data accessing address mapping table with a written data according to a write instruction;
writing said written data into said silicon storage device through said silicon storage device interface from said cache buffer according to said content updated of said data accessing address mapping table; and
writing said data accessing address mapping table into said silicon storage device after completion of writing operation into said silicon storage device.

10. The method as cited in claim 9, wherein said step of writing said written data into said silicon storage device through said silicon storage device interface from said cache buffer processing simultaneously with decoding data of said microprocessor.

11. A method for data transmission of a card reader, wherein said card reader comprising a transmission buffer, a cache buffer, a system interface and a silicon storage device interface, said method comprising:
receiving a first data requested by a read instruction, wherein said first data is received by said transmission buffer;
storing a second data predetermined by said read instruction into said cache buffer when the transmission buffer approaching full status; and
outputting sequentially said data stored in said transmission buffer and said cache buffer.

12. The method as cited in claim 11, said method further comprising a step for comparing said data stored in said buffer following said step of storing said second data, wherein said comparison step determining the first position of said second data following the last position of said first data.

13. The method as cited in claim 11, further comprising:
removing said second data from said cache buffer after outputting said second data.

14. The method as cited in claim 11, wherein said method is alternately and synchronously performed to transmit buffer.

15. The method as cited in claim 11, wherein said card reader further comprising an allocation table buffer, and said method further comprising:
writing a data accessing address mapping table into said allocation table buffer;
updating said content of said data accessing address mapping table with a written data according to a write instruction;
writing said written data into said silicon storage device through said silicon storage device interface from said cache buffer according to said content updated of said data accessing address mapping table; and
writing said data accessing address mapping table into said silicon storage device after completion of writing operation into said silicon storage device.

16. The method as cited in claim 15, wherein said step of writing said written data into said silicon storage device through said silicon storage device interface from said cache buffer processing simultaneously with decoding data of said microprocessor.
